(19) United States
(12) Patent Application Publication
(10) Pub. No.: US 2026/0350974 A1
(43) Pub. Date: Nov. 5, 2026

(54) SYSTEM AND METHOD FOR PROCESSING VISUAL INFORMATION USING A SPATIAL REASONING MODEL

(71) Applicant: PRE INC., TORONTO (CA)

(72) Inventors: PARHAM AARABI, TORONTO (CA); YIQIAN QIN, TORONTO (CA)

(21) Appl. No.: 19/197,440

(22) Filed: May 2, 2025

(51) Int. Cl. G06V 10/82; G06Q 30/0601; G06V 20/50; G06V 30/10

(52) U.S. Cl. CPC G06V 10/82; G06Q 30/0639; G06V 20/50; G06V 30/10

(57) ABSTRACT

System and method for processing visual information is disclosed that employs a Spatial Reasoning Model (SRM). The SRM comprises three primary phases: (1) landmark detection performed by a visual neural network, (2) landmark identification carried out by one or more visual neural networks—including networks specialized for general image identification and optical character recognition (OCR), and (3) analysis using a large language model (LLM) that processes both an input prompt and the detected landmark information. Exemplary applications include evaluating website, application, or design screenshots by correlating user feedback (e.g. tracked engagement information) and reviews with specific design elements, as well as analyzing images of in-store retail locations to suggest design modifications aimed at enhancing retail performance. In an embodiment, analysis is performed using a LLM-based multi-agent system (MAS) comprising a supervisory agent, a plurality of specialized agents and a shared workspace (shred storage and data) to perform the analysis.

### FIELD OF THE INVENTION

The present invention relates generally to image processing and analysis, and more particularly to a system and method that leverages deep neural networks and natural language processing to perform spatial reasoning on visual inputs.

### BACKGROUND

Conventional image processing systems often treat visual analysis and language-based interpretation as separate tasks. Prior techniques may detect features in an image or extract text using OCR, but they typically do not integrate these processes with semantic analysis of user feedback or operational directives. Consequently, these systems are limited in their ability to provide actionable insights for design improvement or optimization in domains such as web/app design and retail environments.

There exists a need for an integrated system that (a) robustly detects and identifies key landmarks within an image, (b) correlates these landmarks with user feedback or operational optimization requests, and (c) produces intelligent, context-aware suggestions to improve the underlying design or spatial arrangement.

### SUMMARY

In one embodiment, the invention provides a Spatial Reasoning Model (SRM) that analyzes visual information through a multi-step process:

Landmark Detection: A visual neural network processes the input image to detect one or more landmarks or significant features.

Landmark Identification: Following detection, the system utilizes additional visual neural networks, including those specialized for general image identification and optical character recognition (OCR), to identify and classify each detected landmark.

LLM-Based Analysis: A large language model (LLM) receives an input prompt, which may include contextual information such as user feedback, reviews, or specific optimization requests. The LLM integrates this textual input with the landmark information to analyze the image semantically and to propose actionable design changes. In an embodiment, LLM-based analysis is performed by a LLM-based multi-agent system, for example, comprising components configured as a supervisory agent, a plurality of (supervised) specialized agents and shared workspace of data storage and shared data to perform the analysis.

Two exemplary applications of the invention include:

Website/App/Design Analysis: Screenshots of a website, application, or design are processed to extract landmark data. The LLM is provided with user reviews and feedback, which it analyzes in association with specific landmarks to identify design elements that may require adjustment.

In-Store Retail Optimization: Images of a retail location are analyzed to extract spatial and landmark information. The LLM is then prompted with a request to optimize the store layout or design, generating suggestions that can improve retail performance.

### BRIEF DESCRIPTION OF THE DRAWINGS

FIG. 1 is a block diagram showing an environment comprising one or more computing devices according to an embodiment herein and in which aspects disclosed herein can be practiced

FIG. 2: A flowchart outlining the method steps from input image processing through to landmark extraction, identification, LLM prompt integration, and output generation of design or optimization recommendations.

FIG. 3: An example application diagram showing the integration of the SRM in analyzing screenshots of a web interface, correlating user feedback with detected design landmarks.

FIG. 4: An example application diagram illustrating the use of the SRM for in-store retail analysis, where extracted landmark information is combined with an optimization prompt to suggest design improvements.

FIG. 5 is a block diagram of a LLM-based multi-agent system (LLM-based MAS) in accordance with an embodiment.

FIG. 6 is an example of output of an LLM-based MAS configured for product recommendation in accordance with an embodiment.

FIGS. 7 and 8 are examples of output of an LLM-based MAS configured for spatial analysis and website design optimization/recommendation in accordance with an embodiment.

### Detailed Description of the Invention

The present invention is described herein with reference to the figures, though the invention is not limited to the specific embodiments shown.

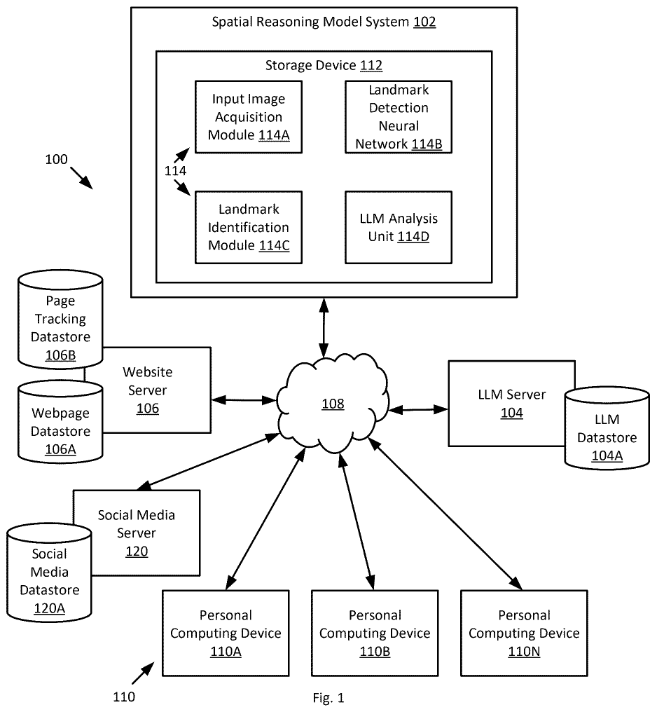

FIG. 1 is a block diagram showing an environment or system architecture 100 comprising one or more computing devices according to an embodiment herein and in which aspects and/or features disclosed herein can be practiced. FIG. 1 shows the overall architecture 100 including a Spatial Reasoning Model (SRM) system 102 (comprising a computing device) according to an embodiment. FIG. 1 further shows SRM system 102 in communication with an LLM server 104 having an LLM datastore 104A and a website server 106 having a webpage datastore 106A and a page tracking datastore 106B. There is further shown a plurality of personal computing devices 110 (e.g. 110A, 110B . . . 110N, where N represents an arbitrary number for the plurality). Devices 110 may comprise a mobile phone, a laptop, a desktop, or a tablet, etc. The computing device of system 102 and the devices 104, 106 and 110 are coupled for communication via a network 108. Network 108 comprises any one or more of a public or private network, or combinations thereof, for example, comprising the internet.

SRM system 102 comprises a storage device 112 storing a plurality of components 112 (e.g. software and/or application components) comprising executable instructions for execution (e.g. by one or more processors) to configure operations of system 102. In an embodiment, the components comprise an input image acquisition module 1124A, a landmark detection neural network 114B, a landmark identification module 114C, and an LLM analysis unit 114D.

While FIG. 1 shows multiple computing devices and datastores, more or fewer computing devices or datastores may be employed. For example, system 102 may comprise an LLM datastore and be configured to provide the LLM. The landmark detection neural network and/or landmark identification module can be configured on one or more other devices. Datastores 106A and 106B may be combined or further divided into additional datastores.

In an embodiment, the image acquisition module 114A receives one or more digital images (e.g., screenshots of a website (e.g. from datastore 106A via server 106) or photographs of an in-store location (e.g. from one of devices 110)). Image acquisition module 114A, in an embodiment, comprises a user interface (UI) for users to upload images, which UI may comprise a web-based interface (not shown).

In an embodiment, landmark detection unit 114B utilizes a trained visual neural network to process the image and detect relevant landmarks. These landmarks may include graphical elements, text regions, icons, or structural features. Examples of trained visual neural network comprise various deep neural networks such as a convolutional neural network. An open-source example of a trained neural network is the VGGnet retrained neural networks such as the VGG16 and VGG19 [Tammina, S., 2019. Transfer learning using vgg-16 with deep convolutional neural network for classifying images. International Journal of Scientific and Research Publications (IJSRP), 9(10), pp. 143-150.]

In an embodiment, landmark identification unit 114C is configured to use (or comprise and use) additional neural networks to classify the detected landmarks. In some embodiments, a general image identification network categorizes objects and elements, while a dedicated optical character recognition OCR neural network extracts textual content. An open-source example of a general image identification network is the YOLO (You Only Look Once) series of image identification networks [Hussain, M., 2023. YOLO-v1 to YOLO-v8, the rise of YOLO and its complementary nature toward digital manufacturing and industrial defect detection. Machines, 11(7), p. 677]. An open-source example of an OCR neural network is the EasyOCR pre-trained network [Salehudin, M. A. M., Basah, S. N., Yazid, H., Basaruddin, K. S., Safar, M. J. A., Som, M. M. and Sidek, K. A., 2023, November. Analysis of optical character recognition using easyocr under image degradation. In Journal of Physics: Conference Series (Vol. 2641, No. 1, p. 012001). IOP Publishing.]

In an embodiment, LLM analysis unit 114D integrates the identified landmarks with an input prompt for processing by a LLM such as via server 104 using datastore 104A. The prompt may include user feedback (e.g., reviews, comments) or operational requests (e.g., design optimization for enhanced retail performance). The LLM server 104 processes this combined data to infer semantic relationships, contextual significance, and to propose actionable recommendations. A commercial example of a LLM is the OpenAI™ GPT-4o multimodal large language model.

In an embodiment, at least some of the personal devices 110 communicate with system 102 to provide images for processing such as website (e.g. webpage) images or other graphical user interface images, application user interface images, in-store or other retail location images (e.g. a photograph or a rendering of a retail environment), etc.

In an embodiment, at least some of the personal devices 110 are configured to define webpages such as stored in datastore 106A and are operated by programmers for defining the webpages. In an embodiment, at least some of the personal devices 110 are configured to define application interfaces of a user application (not shown) for execution by one or more computing devices. In an embodiment, at least some of the devices 110 are configured for web-browsing such as to receive and present webpages processed by system 102 and refined in accordance with any recommendations. In an embodiment, at least some of the devices 110 are configured for executing a user application (not shown) having one or more (e.g. graphical) user interfaces that were processed by system 102 and refined in accordance with any recommendations. In accordance with an embodiment, page tracking data is collected and stored to datastore 106B. Page tracking data collects browsing history data such as when a device browses a website, visiting one or more pages, interacting with the controls, etc. presented via the web pages. The page tracking data comprises, for example, for each session, which pages are visited, time on a page, clicks and other user input (e.g. text input, image upload, mouse over, etc.) or other page engagement data, including, in an e-commerce website, shopping cart activity and other purchase or no purchase information. Tracking data is granular including sequence data and/or time stamped data enabling a reconstruction of a device's engagement with the site. Page tracking data can be aggregated, and/or analyzed such as to determine insights into user/customer engagement and website/page quality or success metrics. Resulting information is stored to datastore 106B in an embodiment. In an embodiment, tracking data related to engagement (e.g. raw, aggregated and/or pre-analyzed) is provided for LLM analysis (e.g. by LLM Analysis unit 114D).

Though FIG. 1 shows a web-based environment to serve pages of a website to at least some of devices 110, similar components will be understood for a native application and application server environment, where the native application (not shown) executes on at least some devices 110, interacting with the application server (not shown). Application interface tracking (e.g. for graphical user interfaces (screens)) similarly stores user tracking data to an application tracking datastore (not shown).

In an embodiment, SRM system 102 has access to information (data) from e.g. on or more other online resources such as data available from social medial platform (e.g. server 120 and its social media datastore 120A) providing a social media service. Social media services are but an example of an online resource for information about products and services. SRM system 102 may have access to other services such as social networking, news, or other media services. Such services may provide user, customer and/or influencer information regarding the products or services provided via website server 106 (or a similar application server (not shown)). Such information may include posts (text and/or images) related to the products or services, customer or other reviews, complaints, recommendations, tips, etc. Though only a single social media server 120 is shown, more than one online resource platform may be available to system 102.

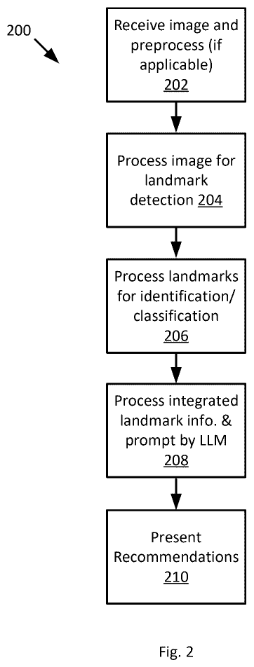

FIG. 2 is a flowchart outlining operations 200 (e.g. method steps) from input image processing through to landmark extraction, identification, LLM prompt integration, and output generation of design or optimization recommendations.

In embodiment, the method for processing visual information using the SRM can be summarized as follows: at step 202: Image receipt, and preprocessing, if necessary, is performed. System 102 (e.g. at 114A) receives an image and may perform preprocessing (e.g., resizing, normalization) to prepare it for neural network analysis. At step 204, landmark detection is performed. A visual neural network processes the image to detect landmarks. This detection phase is designed to be robust, handling varied image conditions. At step 206, landmarks from step 204 are processed for landmark identification/classification. Detected landmarks are passed to one or more specialized neural networks that identify and classify each landmark. For example, OCR is used to extract and interpret text, while image identification networks recognize logos, icons, or other graphic elements.

At step 208: LLM integration and analysis is performed. System 102 (e.g. at 114D) collates the landmark information from step 206 and combines it with a user-specified prompt. The prompt can include qualitative data such as user reviews or explicit design optimization instructions. The LLM analyzes the input holistically, attributing user feedback to specific landmarks and suggesting potential modifications. At step 210, operations provide (e.g. as output) any recommendations such as design change recommendations or optimization strategies. In the context of website/app design, recommendations can address layout or element adjustments; for in-store applications, suggestions might pertain to spatial reconfigurations intended to enhance retail performance. The prompt may be received in association with the input image, such as uploaded or input together or in close time proximity. A user interface of system 102 (e.g. of component 114A) can be provided to receive the prompt.

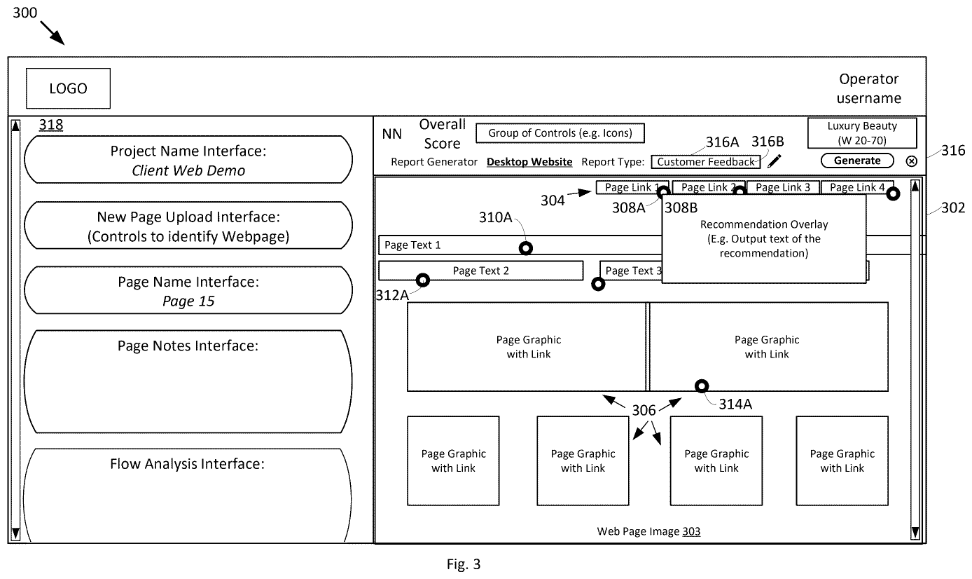

FIG. 3 shows user interface screenshot 300 showing the integration of the SRM in analyzing screenshots of a web interface, correlating user feedback with detected design landmarks. For web/app/design evaluation, in scenarios where a screenshot (e.g. as presented in region 302) or other image of a GUI (e.g. a web page image 303) is analyzed, the system may identify specific elements (e.g., navigation bars, call-to-action buttons (e.g. Page Links 1 to 4 (304 or graphic images 306)) and correlate them with customer feedback. For instance, negative reviews regarding the clarity of navigation could be linked to landmarks representing menu layouts, thereby prompting recommendations for improved interface design.

In the embodiment shown, the feedback analysis is presented via a respective control annotating the image of the web page displayed in interface region 302. The control in the embodiment is represented as a bold circle (e.g. 308A, 310A, 312A and 314A,) that when invoked, such as by hovering over the control (not shown), triggers the display of an overlay recommendation (e.g. 306B)). Feedback with some controls is not shown as only one control is invoked as depicted in the screenshot. In an embodiment “Page Link 1” represents a link for website users to login to the service. The feedback associated with control 308A as presented in an embodiment in overlay 308B may comprise text suggesting “Upon signing in, guiding users to a consolidated help center or contact options page especially highlighting solutions for frequent complaints like missing packages, gift card trouble, or service issues-would give immediate reassurance. This addresses criticisms that customer service often deflects issues or sends customers through frustrating processes.”

In the embodiment, interface region 316 (above the region of interface 302) presents user controls for configuring the analysis. Interface region 318 presents user controls for managing the analysis of a web site or application, identifying specific pages or image for analysis, etc.

Interface region 316 includes a selection control 316A to select between different (LLM) prompt choices for driving the analysis, annotation and presentation of the recommendations. In the depicted embodiment a prompt choice for customer feedback 316B is shown in control 312A. In an embodiment, the actual prompt provided to the LLM is associated with the prompt choice in the control but need not be identical in content given the constraint of the selection control 316A.

In an embodiment, the SRM system 102 is defined to present an interface 300 that shows an annotated image of a website page or software application page following various analysis as previously described in relation to system 100 and flowchart 200. The image is annotated with one or more (or a plurality of respective) controls to present analysis results, the placement/location of the controls in relation to the image is determined by the identification of UI elements by the SRM analysis operations of system 102, etc. The specific content of the recommendations is determined by the LLM analysis of the image as well as output from landmark detection and identification analysis, where the LLM analysis is driven by a respective prompt.

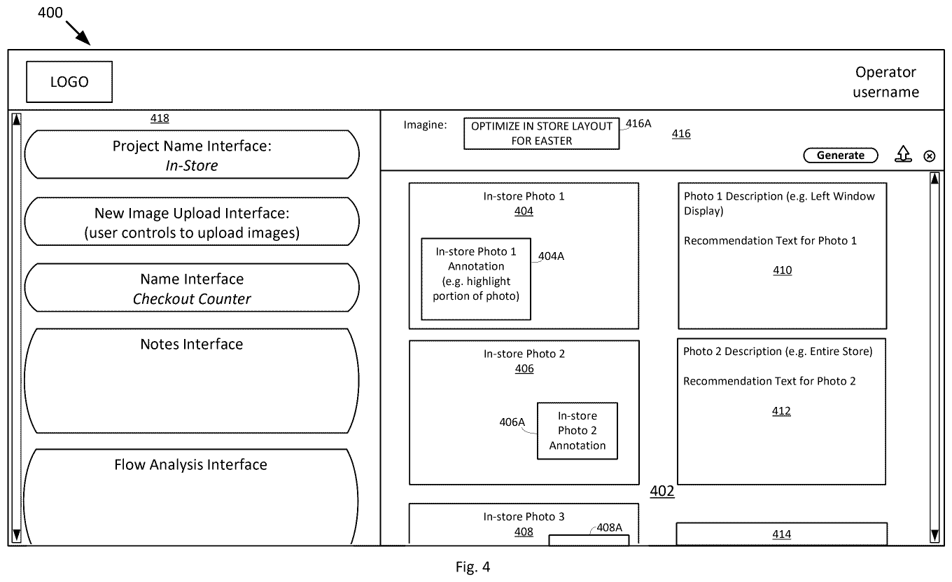

FIG. 4 is user interface screen shot 400 illustrating the use of the SRM for in-store retail analysis, where extracted landmark information is combined with an optimization prompt to suggest design improvements. For retail environment optimization: when applied to images of retail locations, the SRM extracts spatial and structural landmarks (e.g., product displays, signage). The LLM then processes an optimization prompt, generating suggestions for reconfiguring the store layout to improve customer flow and increase sales. Screenshot 400 depicts a similar interface to screenshot 300. In the user interface of screenshot 400, region 402 presents the analyzed images 404, 406, 408, etc. of the retail environment. In an embodiment, a portion of each image (e.g. 404A, 406A, 408A) is annotated such as by highlighting. In an embodiment highlighting comprises a box shape (e.g. rendered) around a region of the image identified by the landmark detection and identification analysis that is meaningful to the recommendation, for example. Portions of the respective image outside the box are masked, such as by overlaying with a (partially) transparent image mask to reduce visibility of the portion of lesser interest. In an embodiment, specific recommendations (e.g. 410, 412 and 414 are presented in association with the images in region 402.

In the embodiment, interface region 416 (above interface region 402) is similar to region 316 but is adapted to a retail environment analysis. Region 416 presents user controls for configuring the analysis, including an text input control 416A to provide a prompt to configure the analysis. In the embodiment the prompt is directed to optimizing the store layout for a holiday promotion (e.g. Easter). Interface region 418 presents user controls for managing the analysis of an instore retail environment, identifying specific photos or image for analysis, etc.

Advantages: Embodiments may provide several advantages including: integrated processing of visual and textual information for enhanced contextual understanding; automated extraction and classification of image features to support detailed spatial reasoning; versatility in application domains, from digital design analysis to physical retail optimization; or an ability to translate user feedback into specific, actionable design recommendations.

One of the applications of Spatial Reasoning Models is the use of Multi-Agent Systems (MAS) and a Global Workspace. Multi-agent systems (MAS) [1]-[4] involve multiple computing entities—agents—working together to solve complex tasks that often exceed the capabilities of any single agent. Inspired from human collective intelligence [5], these agents can be autonomous, reactive, proactive, and social, enabling them to cooperate, coordinate, and negotiate with one another in pursuit of overall goals. In comparison to single-agent systems, MAS exhibit numerous benefits. For example, they leverage distributed problem-solving architecture, where agents tackle portions of a larger problem and share knowledge or partial solutions to reach an overall goal. This division of tasks, coupled with knowledge exchange and parallel computation, empowers MAS to address complex, multi-step challenges more effectively than single-agent systems. In addition, the distributed nature of MAS increases the robustness and fault tolerance of the system when disturbances occur. In the event of one agent fails or encounter obstacles, others can readily take the tasks over to ensure continuity of system operation. Furthermore, MAS exhibit a higher degree of flexibility and scalability. Unlike single-agent systems, MAS can flexibly adjust to dynamic environments by adding, removing or adapting agents [5]-[8].

In recent years, large language models (LLMs) have shown remarkable capabilities in reasoning and planning [9]. These advancements have catalyzed the development of LLM-based multi-agent systems (LLM-based MAS), which harness synergistic collaboration of multiple LLMs to substantially enhance the problem-solving and decision-making capabilities [10]. To date, LLM-based MAS have been adopted in various fields such as industrial engineering [11]-[13], embodied agents [14]-[16], software engineering [17]-[21], and scientific research [22]-[26], representing a significant leap forward in solving intricate problems in dynamic environments. While LLM-based MAS have achieved notable success across diverse domains, several issues remain inadequately addressed. One of them is the method by which the agents exchange information [27].

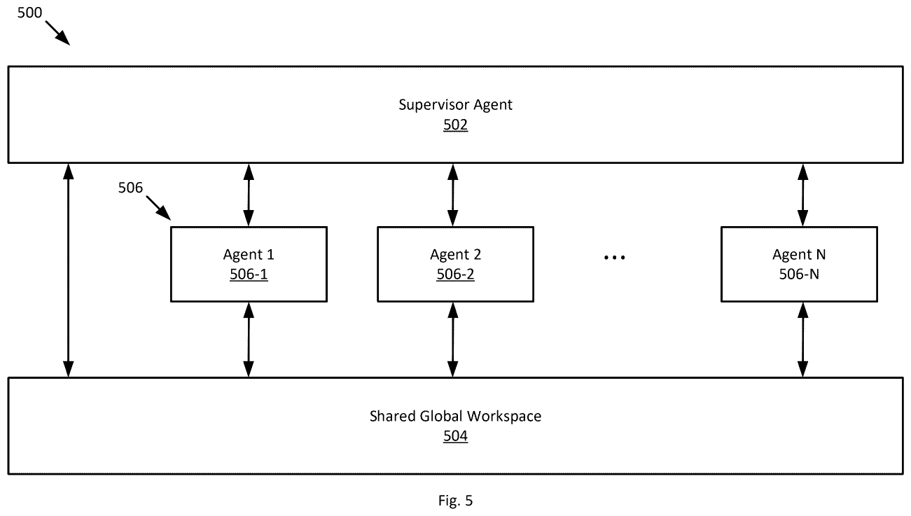

FIG. 5 is a block diagram of an embodiment of a LLM-based MAS (e.g. a system) 500. There is a single supervisor agent 502 and a shared global workspace 504 incorporated into LLM-based MAS 500, allowing agents 506 (e.g. a plurality of agents 1 to N) with diverse capabilities to exchange information seamlessly, thereby enabling them to synchronize progress, foster cooperative exploration, and achieve collective goals with enhanced efficiency [29]. See US20250094474A1, entitled, “Interface for agentic website search” of Siebel et al, which is incorporated herein by reference in its entirety. In an embodiment, system 500 is a component of system 102, for example, as an embodiment of LLM Analysis unit 114D.

In accordance with the embodiment of the LLM-based MAS 500 shown in FIG. 5, a supervisor agent acts like a conductor, orchestrating specific agents (e.g. one or more of agents 506) to proceed and write to the global workspace 504, and to modify, correct, and summarize the global workspace 504 directly. In this LLM-based MAS 500, a single supervisor agent 502 orchestrates the flow of information and work assignments among numerous specialized agents 506. Each specialized agent (e.g. 506-1) operates with distinct goals or tasks, leveraging its unique capabilities to address particular problems. In an embodiment, respective agents are configured through training and/or prompts to simulate specific skills and/or simulate simulated personas. The supervisor agent 502 monitors the progress of the respective agents 506 by intaking their responses in an LLM that has been specially trained (e.g. via fine tune or prompt engineering) to act as the supervisor, allocating tasks as needed and ensuring that their work remains aligned with overall objectives. A shared global workspace 504 serves as the collaborative hub for all agents 502 and 506, enabling them to read and write updates on current projects, intermediate results, and strategic decisions. By consolidating real-time information in one place, the global workspace 504 allows agents 502 and 506 to remain synchronized and efficiently coordinate their efforts. Whenever an agent (e.g. 506-1 to 506-N) makes progress or reaches a milestone, it posts updates to workspace 504 that inform other agents (502 or any of 506) about the most recent developments. This system architecture encourages parallel processing, rapid iteration, and collective intelligence, ultimately leading to more robust and agile decision-making.

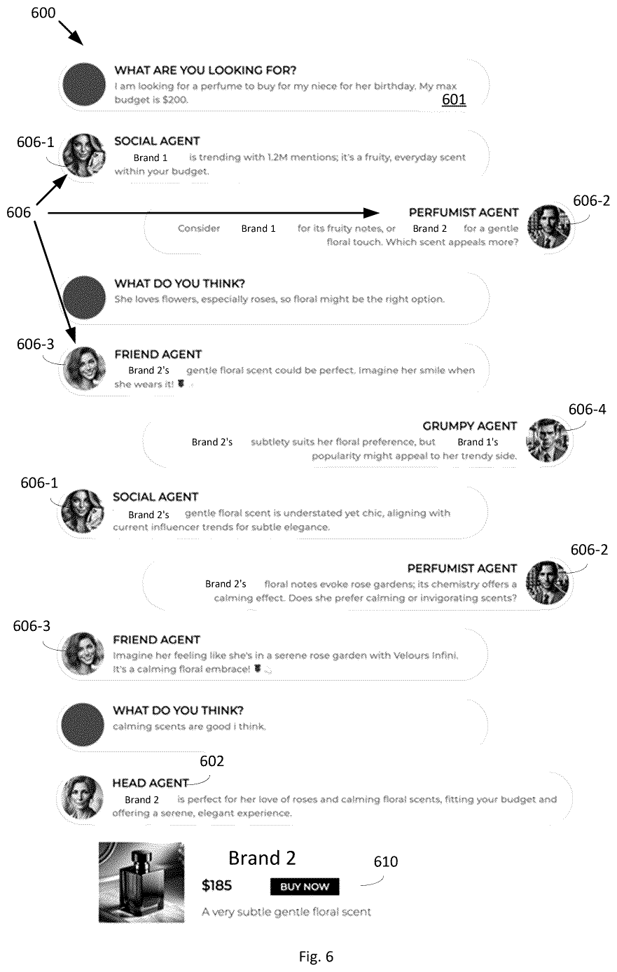

In order to demonstrate the underlying idea, an embodiment of system 500 was defined. In the embodiment, a set of LLM-based agents 506 was created that, along with a supervisor agent 502 and a workspace. can share information, and perform tasks, all to perform an initial request from a user pertaining to finding a perfume. An example of this dialogue 600 is shown in FIG. 6. For example, in an embodiment, the user could specify that “I am looking for a perfume under $200 for my daughter” 602, which would initiate different agents to help with the request. Aside from the supervisor (i.e. head) agent (not shown in FIG. 6), each of the agents (e.g. 506-1 to 506-N, where N=4) had a specific persona. In dialogue 600 the agent's persona's are represented with labels and thumbnails (collectively 606, where the respective personas include a social influencer 606-1, a perfumist 606-2, a friend 606-3, and a grumpy perfume advisor 606-4. In the embodiment of the system 500, each agent 506-1 to 506-N is a LLM with input consisting of a perfume database, a specific task assigned by the supervisor agent 502, write permissibility assigned by the supervisor agent 502, as well as the current contents of the global workspace 504. In an embodiment, of the system 500, LLM's may acquire access via the supervisor agent 502 to external databases/websites, as well as any other relevant information.

In accordance with embodiments of system 500 and other (e.g. novel) techniques herein, the proposed approach can be employed to solve several customer relation problems in various industries. For example, in the beauty industry, LLM-based MAS with a supervisor and global workspace architecture can significantly enhance a wide range of business processes. By harnessing specialized LLM-based agents that focus on tasks such as user persona analysis, product attribute matching, marketing strategy, and content generation, companies can deliver personalized recommendations, promptly answer customer queries, and optimize their online presence. The supervisor agent coordinates these specialized agents to ensure that their individual outputs remain aligned with overall corporate objectives, constantly monitoring performance metrics to pivot strategies as needed.

Through the global workspace, each agent can read and write relevant information in real time, enabling them to update each other on inventory changes, pricing strategies, and emerging product trends. This fosters seamless collaboration and consistent decision-making, allowing for more accurate product recommendations that reflect user preferences and skincare or cosmetic concerns. At the same time, marketing agents can dynamically adjust ads, promotions, and pricing to boost conversion rates and reduce wasted spending. Ultimately, this multifaceted approach offers a cohesive, agile system that supports brands in refining user experiences, increasing profitability, and maintaining a competitive edge. This synergy of intelligence ensures that beauty industry stakeholders can anticipate market shifts and respond to evolving consumer demands.

In an embodiment, a supervisor agent watches for business events—new launches, low safety stock, seasonal pushes—and hands each to specialized agents while tagging every request with a timestamp for later fusion. The marketing-analytics agent streams click, shade-selection, and checkout events from e.g. a software application and/or website, applies sequential pattern mining plus gradient-boosted demand forecasts, and discovers that shoppers glide from the virtual “shade finder” to cart for the peach-glow highlighter yet abandon payment for the ruby-matte lipstick, hinting at price sensitivity or weak visuals. Simultaneously, the customer-relations agent digests live-chat logs, spa-counter transcripts, and product reviews, applies transformer-based sentiment scoring and topic clustering, and surfaces a surge of complaints about six-hour mascara flaking—flagged as a probable quality-control issue. A social-media trends agent harvests images, captions, and hashtags across major beauty platforms, embeds each post in a joint image-text space, applies time-series peak detection, and notes a sharp uptick in the “glass-skin blush” aesthetic, recommending pigment and copy tweaks for a rapid campaign.

Each finding lands in a shared vector knowledge store indexed by product code and moment in time. Graph queries weave together seemingly disparate signals—lipstick cart-drop patterns, mascara fault chatter, and blush trend velocity—so executives see causal links rather than silos. Dashboards translate those joins into concrete actions: redirect ad spend toward the highlighter while testing new pricing images for the lipstick, schedule an accelerated mascara reformulation sprint, and spin up a limited-edition blush bundle that rides the “glass-skin” wave.

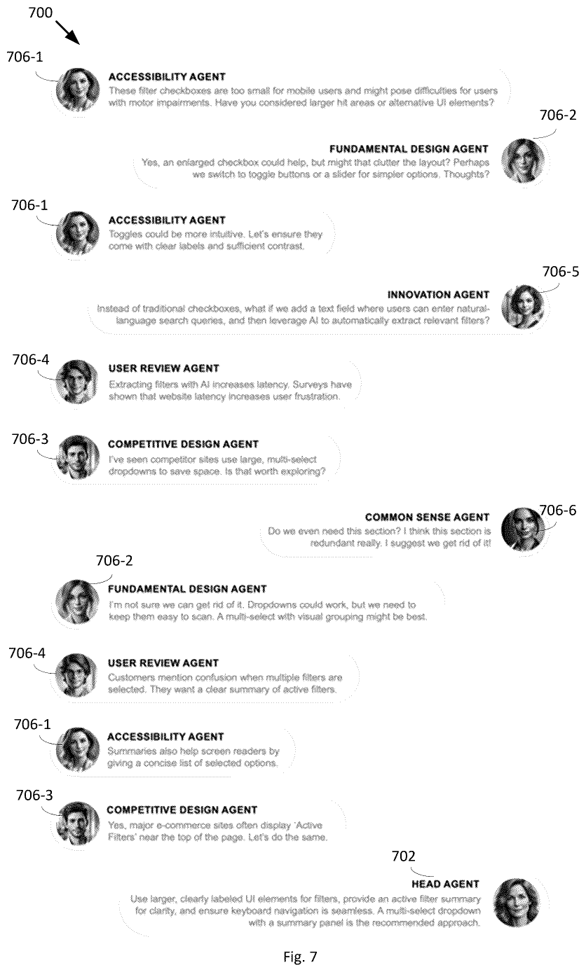

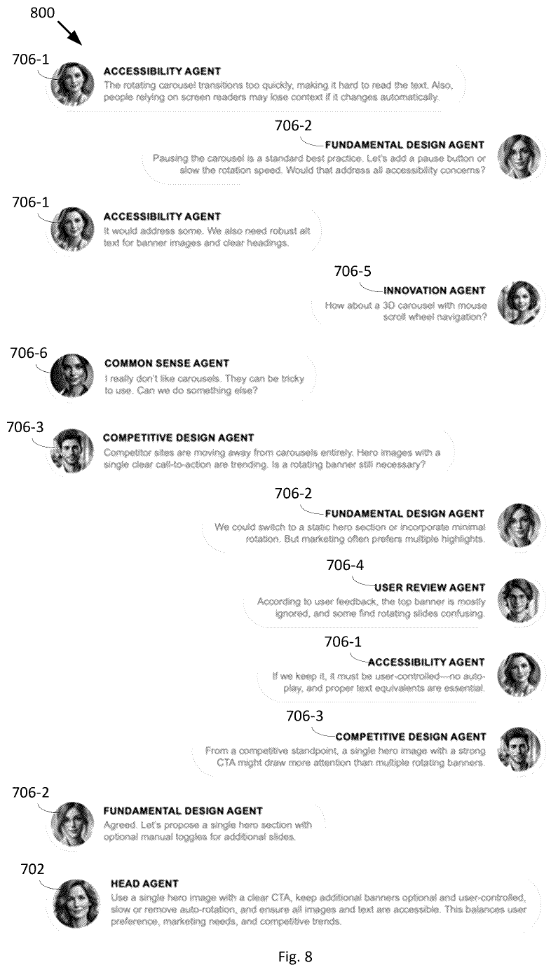

As an example of the above methodology utilized as part of a spatial reasoning model, this approach was tested in the context of agents tasked with giving feedback on an e-commerce website design. First the e-commerce website design is spatially analyzed via a spatial landmark detection as outlined earlier via a spatial neural network. Then the elements of the landmark detection are analyzed by means of a visual neural network as well as a OCR neural network, again as outlined earlier. This information is then used alongside the image (e.g. of the website) by a multimodal LLM multi-agent system to provide analysis. In the embodiment, output comprises a simulated dialogue among agents and FIG. 7 and FIG. 8 illustrate example inter-agent communication between the different agents.

In this embodiment of the LLM-based MAS 500, the system 500 comprises six specialized agents (e.g. 506-1 to 506-N, where N=6) for functions or tasks of: Accessibility, Fundamental Design, Competitive Design, User Review, Innovation, and Common Sense plus a seventh head agent (e.g. 502). Each specialized agent (one of 506-1 to 506-N) posts its observations, proposals, and rebuttals to the shared global workspace 504, and the head agent 502 collects these into final recommendations for the e-commerce site owner.

In the embodiment, the Accessibility agent (in FIGS. 7 and 8 represented with label and thumbnail 706-1) evaluates site elements for compliance with accessibility standards. It checks color contrast, screen reader compatibility, keyboard navigation, and more, flagging issues such as insufficient contrast or missing ARIA labels. The Fundamental Design agent (represented with label and thumbnail 706-2) applies universal guidelines, such as consistent navigation and well-structured layouts. It suggests improvements that follow recognized best practices, ensuring visual and functional consistency. The Competitive Design agent (represented with label and thumbnail 706-3) reviews how other e-commerce sites handle the same or similar design elements, proposing solutions that align with (or surpass) industry trends. The User Review agent (represented with label and thumbnail 706-4) analyzes feedback from emails, reviews, and surveys, identifying pain points common to customers and translating them into actionable design changes. The Innovation agent (represented with label and thumbnail 706-5) introduces creative design ideas, challenging existing design components and catalyzing innovative solutions to the problem. The Common Sense agent (represented with label and thumbnail 706-6) questions the ideas of the other agents, and asks disruptive questions about the validity of placements/promotions/visuals/text. The goal of the Common Sense agent is to disrupt group thinking and inject fresh perspectives into the agent thought processes. Finally, the head agent (represented with label and thumbnail 702) compiles and merges all inputs into a unified report.

By following this routine for each element of the site, the five specialized agents ensure that every perspective—accessibility, foundational design, competitive insights, and direct user feedback—receives equal consideration. Their recommendations are stored in the workspace, visible to the other agents, which fosters continuous refinement as they factor in new or contradictory information. Once discussions reach a point of consensus or complementary overlap, the head agent compiles a clear, actionable set of directives that the site owner can implement to enhance usability, maintain industry relevance, and address real customer needs.

Any computing device herein can be implemented using one or more processors and storage device(s) storing instructions that, when executed, cause the computing device to perform operations. Examples of hardware include a general-purpose central processing unit (CPU) programmed using software, a graphical processing unit (GPU) also as programmed or other processor, microprocessor, or microcontroller options having sufficient resources and capacity.

It is understood that other types of circuitry than programmable processors can be configured. Hardware components comprising specifically designed circuits can be employed such as but not limited to an application specific integrated circuit (ASIC) or other hardware designed to perform specific functions, which may be more efficient in comparison to a general-purpose CPU programmed using software. Thus, broadly herein an apparatus aspect relates to a system or device having circuitry (sometimes referenced as computational circuitry) that is configured to perform certain operations described herein, such as, but not limited, to those of a method aspect herein, whether the circuitry is configured via programming or via its hardware design.

Operations may be performed in parallel, sequentially or in a different order than set forth where logical and/or practical to do so.

A person of skill in the art will understand that there is provided a method aspect, a system aspect and a computer program product aspect in accordance with the following numbered statements.

Statement 1: A method for processing visual information, comprising steps: a) receiving an input image; b) detecting one or more landmarks in the image using a visual neural network; c) identifying the detected landmarks using one or more additional neural networks, wherein at least one of the additional neural networks is configured for image identification and at least one is configured for optical character recognition; d) receiving an input prompt comprising contextual information including user feedback or an optimization request; and e) analyzing the input prompt in conjunction with the identified landmark information using a large language model to generate recommendations for design modifications.

Statement 2: The method of Statement 1, wherein the input image comprises a screenshot of a website, application, or design, and wherein the recommendations include suggestions for altering design elements to address user feedback.

Statement 3: The method of Statement 2, wherein the user feedback includes tracked information associated with user engagement with the website, application or design.

Statement 4: The method of any one of Statements 1 to 3, wherein the input image comprises an image of an in-store retail location, and wherein the recommendations include suggestions for spatial reconfiguration to optimize retail performance.

Statement 5: The method of any one of Statements 1 to 4, wherein the analyzing is performed using a LLM-based multi-agent system comprising a supervisory agent and a plurality of specialized agents having respective functions and/or simulated personalities, the supervisory agent configured to delegate analysis and generate a final output from respective analysis results generated by the plurality of specialized agents and stored to a shared workspace.

Statement 6: The method of any one of Statements 1 to 5, wherein the landmark detection and identification are performed in parallel or sequentially, and wherein the identified landmarks include both graphical elements and textual content.

Statement 7: The method of any one of Statements 1 to 6, further comprising the step of preprocessing the input image to enhance the accuracy of the landmark detection.

Statement 8: A system for processing visual information, comprising: a) an image acquisition module configured to receive one or more digital images; b) a landmark detection module comprising a visual neural network configured to detect landmarks within the image; c) a landmark identification module comprising one or more neural networks configured to classify the detected landmarks, including an optical character recognition network; d) a large language model analysis module configured to analyze an input prompt, wherein the input prompt includes contextual information such as user feedback or an optimization directive; and e) an output module configured to generate recommendations for design or spatial modifications based on the analysis.

Statement 9: The system of Statement 8, wherein the input prompt comprises reviews or feedback related to a web, application, or design interface, and wherein the recommendations aim to address deficiencies in the interface.

Statement 10: The system of Statement 9, wherein the user feedback includes tracked information associated with user engagement with the website, application or design.

Statement 11: The system of Statement 8, wherein the input prompt comprises a request for optimizing a retail store layout, and wherein the recommendations aim to enhance retail performance through spatial design modifications.

Statement 12: The system of any one of Statements 8 to 11, wherein the large language model analysis module comprises a LLM-based multi-agent system (MAS), the LL-based MAS configured to provide a supervisory agent and a plurality of specialized agents having respective functions and/or simulated personalities, the supervisory agent configured to delegate analysis tasks to respective specialized agents and generate a final output from respective analysis results generated by the plurality of specialized agents, the analysis tasks performed using and the results stored to a shared workspace.

Statement 13: A computer program product comprising a non-transient storage medium storing instructions executable by a computing device having one or more processors, the instructions configuring the computing device to perform the method of any one of Statements 1 to 7.

Practical implementation may include any or all the features described herein. These and other aspects, features and various combinations may be expressed as methods, apparatus, systems, means for performing functions, program products, and in other ways, combining the features described herein. Several embodiments have been described. Nevertheless, it will be understood that various modifications can be made without departing from the spirit and scope of the processes and techniques described herein. In addition, other steps can be provided, or steps can be eliminated, from the described process, and other components can be added to, or removed from, the described systems. Accordingly, other embodiments are within the scope of the following claims.

Throughout the description and claims of this specification, the word “comprises” and “contain” and variations of them mean “including but not limited to” and they are not intended to (and do not) exclude other components, integers or steps. Throughout this specification, the singular encompasses the plural unless the context requires otherwise. Where the indefinite article is used, the specification is to be understood as contemplating plurality as well as singularity, unless the context requires otherwise.

Features, integers characteristics, compounds, chemical moieties or groups described in conjunction with a particular aspect, embodiment or example of the invention are to be understood to be applicable to any other aspect, embodiment or example unless incompatible therewith. All the features disclosed herein (including any accompanying claims, abstract and drawings), and/or all the steps of any method or process so disclosed, may be combined in any combination, except combinations where at least some of such features and/or steps are mutually exclusive. The invention is not restricted to the details of any foregoing examples or embodiments. The invention extends to any novel one, or any novel combination, of the features disclosed in this specification (including any accompanying claims, abstract and drawings) or to any novel one, or any novel combination, of the steps of any method or process disclosed.

### CONCLUSION

The disclosed system and method provide an integrated approach to processing visual information through a Spatial Reasoning Model (SRM). By combining landmark detection, landmark identification, and LLM-based contextual analysis, embodiments and other teachings herein effectively translate complex visual data and textual input into actionable design recommendations. This invention is applicable across a variety of domains including digital interface evaluation and physical retail optimization, thereby addressing the limitations of prior art and offering significant improvements in automated visual analysis.

LIST OF REFERENCES

Each of the following is incorporated herein by reference.
[1] M. Wooldridge, An Introduction to MultiAgent Systems. John Wiley & Sons, 2009.
[2] K. Tuyls, K. Tumer, and G. Weiss, “Multiagent Learning,” in Multiagent System. 2013, pp. 423-475.
[3] Y. Shoham and K. Leyton-Brown, Multiagent Systems: Algorithmic, Game-Theoretic, and Logical Foundations. Cambridge University Press, 2008.
[4] N. R. Jennings, K. Sycara, and M. Wooldridge, “A roadmap of agent research and development,” Autonomous Agents and Multi-Agent Systems, vol. 1, no. 1, pp. 7-38, 1998.
[4] K.- T. Tran, D. Dao, M. -D. Nguyen, Q. -V. Pham, B. O'Sullivan, and H. D. Nguyen, “Multi-Agent Collaboration Mechanisms: A Survey of LLMs,” arXiv.org. Accessed: Mar. 7, 2025. [Online]. Available: https://arxiv.org/abs/2501.06322
[6] P. G. Balaji and D. Srinivasan, “An Introduction to Multi-Agent Systems,” Springer Berlin Heidelberg. [Online]. Available: https://link.springer.com/chapter/10.1007/978-3-642-14435-6_1
[7] X. Li, S. Wang, S. Zeng, Y. Wu, and Y. Yang, “A survey on LLM-based multi-agent systems: workflow, infrastructure, and challenges,” Vicinagearth, vol. 1, no. 1, 2024, doi: 10.1007/s44336-024-00009-2.
[8] A. Dorri, S. S. Kanhere and R. Jurdak, “Multi-Agent Systems: A Survey,” in IEEE Access, vol. 6, pp. 28573-28593, 2018, doi: 10.1109/ACCESS.2018.2831228.
[9] OpenAI et al., “GPT-4Technical Report,” arXiv. org. Accessed: Mar. 12, 2025. [Online]. Available: https://arxiv.org/abs/2303.08774
[10] T. Guo et al., “Large Language Model Based Multi-agents: A Survey of Progress and Challenges,” in Proceedings of the Thirty-Third International Joint Conference on Artificial Intelligence, California: International Joint Conferences on Artificial Intelligence Organization, Aug. 2024. Accessed: Mar. 15, 2025. [Online]. Available: https://doi.org/10.24963/ijcai.2024/890
[11] Y. Xia, M. Shenoy, N. Jazdi, and M. Weyrich, “Towards autonomous system: flexible modular production system enhanced with large language model agents,” in 2023 IEEE 28th International Conference on Emerging Technologies and Factory Automation (ETFA), IEEE, Sep. 2023, pp. 1-8. Accessed: Mar. 9, 2025. [Online]. Available: https://doi.org/10.1109/etfa54631.2023.10275362
[12] J. Lim, B. Vogel-Heuser, and I. Kovalenko, “Large Language Model-Enabled Multi-Agent Manufacturing Systems,” in 2024 IEEE 20th International Conference on Automation Science and Engineering (CASE), IEEE, Aug. 2024, pp. 3940-3946. Accessed: Mar. 15, 2025. [Online]. Available: https://doi.org/10.1109/case59546.2024.10711432
[13] Y. Xia, Z. Xiao, N. Jazdi, and M. Weyrich, “Generation of Asset Administration Shell With Large Language Model Agents: Toward Semantic Interoperability in Digital Twins in the Context of Industry 4.0,” IEEE Access, vol. 12, pp. 84863-84877, 2024, doi:10.1109/access.2024.3415470.
[14] W. Huang et al., “Inner Monologue: Embodied Reasoning through Planning with Language Models,” arXiv. org. Accessed: Mar. 10, 2025. [Online]. Available: https://arxiv.org/abs/2207.05608
[15] J. Wu et al., “TidyBot: personalized robot assistance with large language models,” Autonomous Robots, vol. 47, no. 8, pp. 1087-1102, Nov. 2023, doi: 10.1007/s10514-023-10139-z.
[16] C. H. Song, B. M. Sadler, J. Wu, W. -L. Chao, C. Washington, and Y. Su, “LLM-Planner: Few-Shot Grounded Planning for Embodied Agents with Large Language Models,” in 2023 IEEE/CVF International Conference on Computer Vision (ICCV), IEEE, Oct. 2023, pp. 2986-2997. Accessed: Mar. 15, 2025. [Online]. Available: https://doi.org/10.1109/iccv51070.2023.00280
[17] C. Qian et al., “ChatDev: Communicative Agents for Software Development,” in Proceedings of the 62nd Annual Meeting of the Association for Computational Linguistics (Volume 1: Long Papers), Stroudsburg, PA, USA: Association for Computational Linguistics, 2024, pp. 15174-15186. Accessed: Mar. 12, 2025. [Online]. Available: https://doi.org/10.18653/v1/2024.acl-long.810
[18] W. Tao, Y. Zhou, Y. Wang, W. Zhang, H. Zhang, and Y. Cheng, “MAGIS: LLM-Based Multi-Agent Framework for GitHub Issue Resolution,” Advances in Neural Information Processing Systems, vol. 37, pp. 51963-51993, Dec. 2024.
[19] A. G. Khoee, Y. Yu, R. Feldt, A. Freimanis, P. A. Rhodin, and D. Parthasarathy, “GoNoGo: An Efficient LLM-Based Multi-agent System for Streamlining Automotive Software Release Decision-Making,” in Lecture Notes in Computer Science, Cham: Springer Nature Switzerland, 2025, pp. 30-45. Accessed: Mar. 15, 2025. [Online]. Available: https://doi.org/10.1007/978-3-031-80889-0_3
[20] J. He, C. Treude, and D. Lo, “LLM-Based Multi-Agent Systems for Software Engineering: Literature Review, Vision and the Road Ahead,” ACM Transactions on Software Engineering and Methodology, Jan. 2025, doi: 10.1145/3712003.
[21] P. Kargupta, I. Agarwal, D. H. Tur, and J. Han, “Instruct, Not Assist: LLM-based Multi-Turn Planning and Hierarchical Questioning for Socratic Code Debugging,” in Findings of the Association for Computational Linguistics: EMNLP 2024, Stroudsburg, PA, USA: Association for Computational Linguistics, 2024, pp. 9475-9495. Accessed: Mar. 16, 2025. [Online]. Available: https://doi.org/10.18653/v1/2024.findings-emnlp.553
[22] A. Ghafarollahi and M. J. Buehler, “ProtAgents: protein discovery via large language model multi-agent collaborations combining physics and machine learning,” Digital Discovery, vol. 3, no. 7, pp. 1389-1409, 2024, doi:
10.1039/d4dd00013g.
[23] A. M. Bran, S. Cox, O. Schilter, C. Baldassari, A. D. White, and P. Schwaller, “Augmenting large language models with chemistry tools,” Nature Machine Intelligence, vol. 6, no. 5, pp. 525-535, May 2024, doi:10.1038/s42256-024-00832-8.
[24] H. Su et al., “Many Heads Are Better Than One: Improved Scientific Idea Generation by A LLM-Based Multi-Agent System,” arXiv.org.[Online]. Available: https://arxiv.org/abs/2410.09403

B. Ni and M. J. Buehler, “MechAgents: Large language model multi-agent collaborations can solve mechanics problems, generate new data, and integrate knowledge,” Extreme Mechanics Letters, vol. 67, p. 102131, Mar. 2024, doi: 10.1016/j.eml.2024.102131.
[26] D. A. Boiko, R. MacKnight, and G. Gomes, “Emergent autonomous scientific research capabilities of large language models,” arXiv.org. [Online]. Available: https://arxiv.org/abs/2304.05332
[27] S. Han, Q. Zhang, Y. Yao, W. Jin, Z. Xu, and C. He, “LLM Multi-Agent Systems: Challenges and Open Problems,” arXiv. org. Accessed: Mar. 9, 2025. [Online]. Available: https://arxiv.org/abs/2402.03578
[28] M. Abdelwahab and P. Aarabi, “The Global Workspace Theory: A Step Towards Artificial General Intelligence,” 2023 IEEE Conference on Artificial Intelligence (CAI), Jun. 2023, pp. 280-281, doi:10.1109/CAI54212.2023.00125
[29] T. Siebel, N. Krishnan, L. Poirier, R. Juban, M. Haines, Y. Homma and R. Muradov, “Interface for Agentic Web Search”, US Patent Publication US2025009447A1, Mar. 20, 2025.

1. A method for processing visual information, comprising:
a) receiving an input image;
b) detecting one or more landmarks in the image using a visual neural network;
c) identifying the detected landmarks using one or more additional neural networks, wherein at least one of the additional neural networks is configured for image identification and at least one is configured for optical character recognition;
d) receiving an input prompt comprising contextual information including user feedback or an optimization request; and
e) analyzing the input prompt in conjunction with the identified landmark information using a large language model to generate recommendations for design modifications.

2. The method of claim 1, wherein the input image comprises a screenshot of a website, application, or design, and wherein the recommendations include suggestions for altering design elements to address user feedback.

3. The method of claim 2, wherein the user feedback includes tracked information associated with user engagement with the website, application or design.

4. The method of claim 1, wherein the input image comprises an image of an in-store retail location, and wherein the recommendations include suggestions for spatial reconfiguration to optimize retail performance.

5. The method of claim 1, wherein the landmark detection and identification are performed in parallel or sequentially, and wherein the identified landmarks include both graphical elements and textual content.

6. The method of claim 1, further comprising the step of preprocessing the input image to enhance the accuracy of the landmark detection.

7. The method of claim 1, wherein the analyzing is performed using a LLM-based multi-agent system comprising a supervisory agent and a plurality of specialized agents having respective functions and/or simulated personalities, the supervisory agent configured to delegate analysis and generate a final output from respective analysis results generated by the plurality of specialized agents and stored to a shared workspace.

8. A system for processing visual information, comprising:
a) an image acquisition module configured to receive one or more digital images;
b) a landmark detection module comprising a visual neural network configured to detect landmarks within the image;
c) a landmark identification module comprising one or more neural networks configured to classify the detected landmarks, including an optical character recognition network;
d) a large language model analysis module configured to analyze an input prompt, wherein the input prompt includes contextual information such as user feedback or an optimization directive; and
e) an output module configured to generate recommendations for design or spatial modifications based on the analysis.

9. The system of claim 8, wherein the input prompt comprises reviews or feedback related to a web, application, or design interface, and wherein the recommendations aim to address deficiencies in the interface.

10. The system of claim 9, wherein the user feedback includes tracked information associated with user engagement with the website, application or design.

11. The system of claim 8, wherein the input prompt comprises a request for optimizing a retail store layout, and wherein the recommendations aim to enhance retail performance through spatial design modifications.

12. The system of claim 8, wherein the large language model analysis module comprises a LLM-based multi-agent system (MAS), the LL-based MAS configured to provide a supervisory agent and a plurality of specialized agents having respective functions and/or simulated personalities, the supervisory agent configured to delegate analysis tasks to respective specialized agents and generate a final output from respective analysis results generated by the plurality of specialized agents, the analysis tasks performed using and the results stored to a shared workspace.

13. A computer program product comprising a non-transient storage device
storing instructions executable by a computing device having one or more processors, the instructions configuring the computing device to perform a method comprising steps of:
a) receiving an input image;
b) detecting one or more landmarks in the image using a visual neural network;
c) identifying the detected landmarks using one or more additional neural networks, wherein at least one of the additional neural networks is configured for image identification and at least one is configured for optical character recognition;
d) receiving an input prompt comprising contextual information including user feedback or an optimization request; and
e) analyzing the input prompt in conjunction with the identified landmark information using a large language model to generate recommendations for design modifications.

14. The computer program product of claim 13, wherein the input image comprises a screenshot of a website, application, or design, and wherein the recommendations include suggestions for altering design elements to address user feedback.

15. The computer program product of claim 14, wherein the user feedback includes tracked information associated with user engagement with the website, application or design.

16. The computer program product of claim 13, wherein the input image comprises an image of an in-store retail location, and wherein the recommendations include suggestions for spatial reconfiguration to optimize retail performance.

17. The computer program product of claim 13, wherein the landmark detection and identification are performed in parallel or sequentially, and wherein the identified landmarks include both graphical elements and textual content.

18. The computer program product of claim 13, wherein the analyzing is performed using a LLM-based multi-agent system comprising a supervisory agent and a plurality of specialized agents having respective functions and/or simulated personalities, the supervisory agent configured to delegate analysis to respective ones of the specialized agents and generate a final output from respective analysis results generated by specialized agents, the supervisory agent and the plurality of specialized agents configure to use a shared workspace to store analysis and results for sharing therebetween.
